(19) United States
(12) Patent Application Publication
(10) Pub. No.: US 2008/0115619 A1
(43) Pub. Date: May 22, 2008

(54) Armature of steering wheel

(76) Inventor: Sung Hun Cho, Anyang-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/647,075

(22) Filed: Dec. 28, 2006

(30) Foreign Application Priority Data
Nov. 16, 2006 (KR) 10-2006-0113500

(51) Int. Cl. B62D 1/04

(52) U.S. Cl. 74/552

(57) ABSTRACT

An armature of a steering wheel that can be used for various steering wheels by changing a position of a spoke when assembling with a hub and a rim. An exemplary embodiment provides an armature of a steering wheel, including a rim; a hub disposed in a middle portion of the rim; and at least one spoke having one end portion combined with the hub and the other end portion combined with the rim, wherein, when the spoke is combined with the rim and the hub, the number and the location of the spoke can be changed.

### CROSS-REFERENCE TO RELATED APPLICATION

This application claims priority to and the benefit of Korean Patent Application No. 10-2006-0113500 filed in the Korean Intellectual Property Office on Nov. 16, 2006, the entire contents of which are incorporated herein by reference.

### BACKGROUND OF THE INVENTION

(a) Field of the Invention

The present invention relates to an armature of a steering wheel. More particularly, the present invention relates to an armature of a steering wheel that can be used for various steering wheels by changing the position of a spoke when assembling with the hub and rim.

(b) Description of the Related Art

Generally, a steering wheel is a part that is operated by a driver in order to change a driving direction of a vehicle. In order to satisfy various requests of users, steering wheels are manufactured in various types. For example, the number of spokes can be varied, such as two, threes or four spokes. Furthermore, even if the number of spokes is the same, the type of steering wheel can be varied according to a position of the spokes.

As the types of steering wheels increase, the armatures used for the steering wheels should also be formed as various types. In a conventional armature, a rim, a hub, and a spoke are integrally formed, and thus the armature should be independently formed consistent with the steering wheel. Therefore, when a type of an armature is set, a steering wheel using the armature is also determined consistent with the type of the armature.

Accordingly, there is much time and cost involved in developing and manufacturing molds according to the types of armatures.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide an armature of a steering wheel having the advantage of being capable of use with various steering wheels by changing a position of a spoke when assembling with a rim and a hub.

An exemplary embodiment of the present invention provides an armature of a steering wheel including: a rim; a hub disposed in a middle portion of the rim; and at least one spoke having one end portion combined with the hub and the other end portion combined with the rim, wherein, when the spoke is combined with the rim and the hub, the number of spokes and the location thereof can be changed.

The hub can include: a base plate with a plurality of first insert grooves, the first insert grooves being formed at a top surface of the base plate and the spoke being inserted therein; an upper plate with a plurality of second insert grooves corresponding to the first insert grooves, the second insert grooves being formed at a bottom surface of the base plate; and a cover plate for combining the base plate and the upper plate.

A first coupling hole can be provided at the end portion of the spoke to be combined with the hub, second coupling holes can be provided at the first insert grooves, third coupling holes can be provided at the second insert grooves, and a plurality of coupling pins can be provided at a bottom surface of the cover plate, wherein the coupling pins are simultaneously inserted into the first, the second, and the third coupling holes so as to combine the spoke, the base plate, and the upper plate.

The position where the spoke is inserted into the plurality of first insert grooves can be changed, to thereby change the location of the spoke when combined with the rim and the hub.

The cover plate can be combined with the upper plate by a hinge.

The other end portion of the spoke can be provided with a clip for hooking the rim.

### BRIEF DESCRIPTION OF THE DRAWINGS

FIG. 1 is a perspective view showing an assembled armature of a steering wheel consistent with an exemplary embodiment of the present invention.

FIG. 2 is an exploded assembly view of an armature of a steering wheel consistent with an exemplary embodiment of the present invention.

FIG. 3 is a perspective view showing a bottom surface of an upper plate of an armature of a steering wheel consistent with an exemplary embodiment of the present invention.

FIG. 4 is an exploded perspective view showing assembly of a spoke and a hub at an armature of a steering wheel consistent with an exemplary embodiment of the present invention.

FIG. 5 shows various armatures of steering wheels and steering wheels manufactured by using the various armatures according to an exemplary embodiment of the present invention.

### DETAILED DESCRIPTION OF THE EMBODIMENT

An exemplary embodiment of the present invention will hereinafter be described in detail with reference to the accompanying drawings.

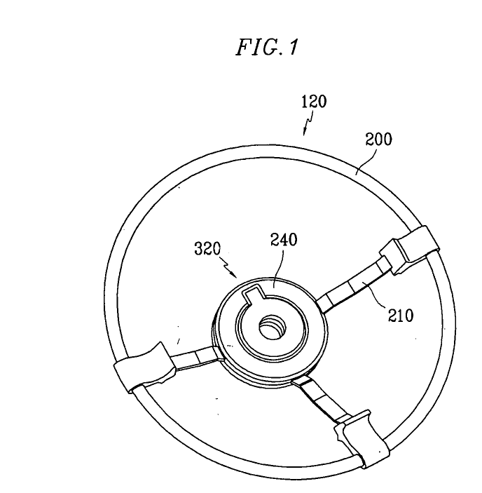

As shown in FIG. 1, an armature 120 of a steering wheel consistent with an exemplary embodiment of the present invention includes a rim 200, a hub 320, and at least one of spoke 210. The rim 200 forms an external frame of the armature 120.

A steering column (not shown) is interposed at a middle portion of the hub 320 and combined with a steering axle (not shown).

The spoke 210 has one end portion combined with the hub 320 and the other end portion combined with the rim 200, and thus it connects the hub 320 with the rim 200. The number of spokes 210 can be determined according to need by a person of an ordinary skill in the art.

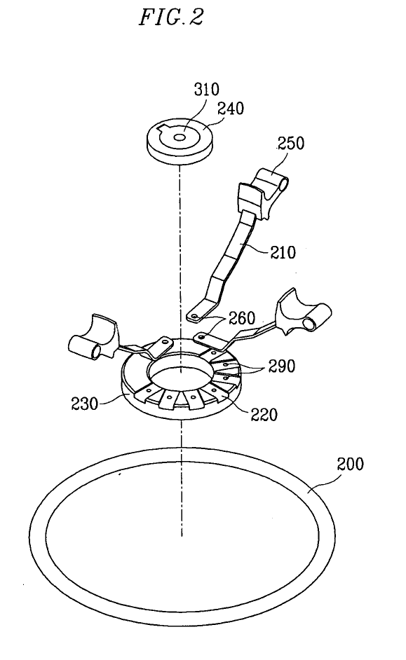

As shown in FIG. 2, the spoke 210 is provided with a first coupling hole 260 at one end portion and a clip 250 at the other end portion. The clip 250 hooks the rim 200 so as to connect the spoke 210 with the rim 200. The hub 320 includes a base plate 230, an upper plate 240, and a cover plate 310.

The base plate 230 is provided with a plurality of first insert grooves 220 at a top surface thereof. Each of the first insert grooves 220 is provided with a second coupling hole 290. The one end portion of the spoke 210 is inserted into at least one among the plurality of first insert grooves 220.

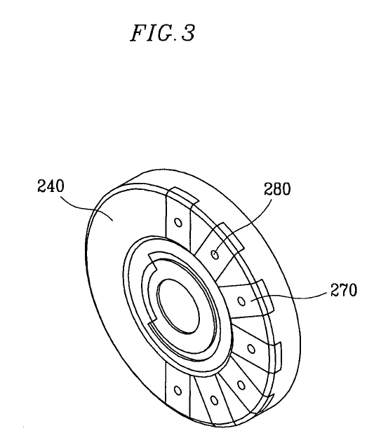

As shown in FIG. 3, the upper plate 240 is provided with a plurality of second insert grooves 270 corresponding to the first insert grooves 220 of the base plate 230 at one surface. Each of the second insert grooves 270 is provided with a third coupling hole 280.

When the base plate 230 is combined with the upper plate 240, the first insert grooves 220 of the base plate 230 and the second insert grooves 270 of the upper plate 240 form a plurality of spaces, and the one end portion of the spoke 210 is inserted into at least one among the plurality of spaces.

Consequently, various armatures 120 can be formed according to the positions of the first and second insert grooves 220, 270 into which the spoke 210 is inserted and the number of spokes 210.

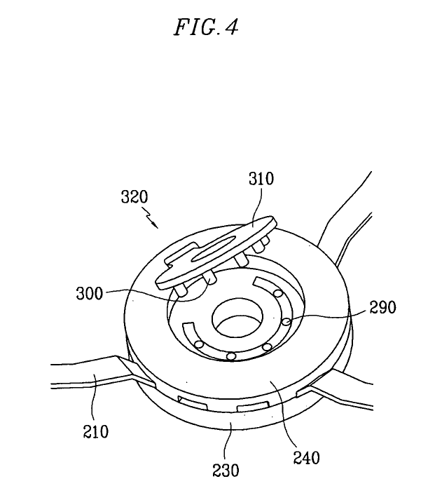

As shown in FIG. 4, the cover plate 310 is provided with a plurality of coupling pins 300 at one surface thereof. When the hub 320 and the spoke 210 are combined, the coupling pins 300 are inserted into the second coupling holes 290 of the base plate 230, the first coupling hole 260 of the spoke 210, and the third coupling holes 280 of the upper plate 240 so as to combine the base plate 230, the spoke 210, and the upper plate 240. The cover plate 310 can be combined with the upper plate 240 by a hinge.

Hereinafter, an assembly process of an armature of a steering wheel according to an exemplary embodiment of the present invention will be described in detail.

After a type of armature 120 and the number of spokes 210 are determined, the one end portion of the spoke 210 is inserted into a predetermined first insert groove 220 among the plurality of first insert grooves 220 of the base plate 230 so as to be consistent with the type of armature 120.

Subsequently, after the upper plate 240 is disposed on the base plate 230, the plurality of coupling pins 300 of the cover plate 310 are simultaneously inserted into the third coupling holes 280 of the upper plate 240, the first coupling hole 260 of the spoke 210, and the second coupling holes 290 of the base plate 230, and thus the upper plate 240, the spoke 210, and the base plate 230 are combined. The hub 320 and the rim 200 are connected by hooking the rim 200 with the clip 250 located at the other end portion of the spoke 210, and thus the armature 120 is completed.

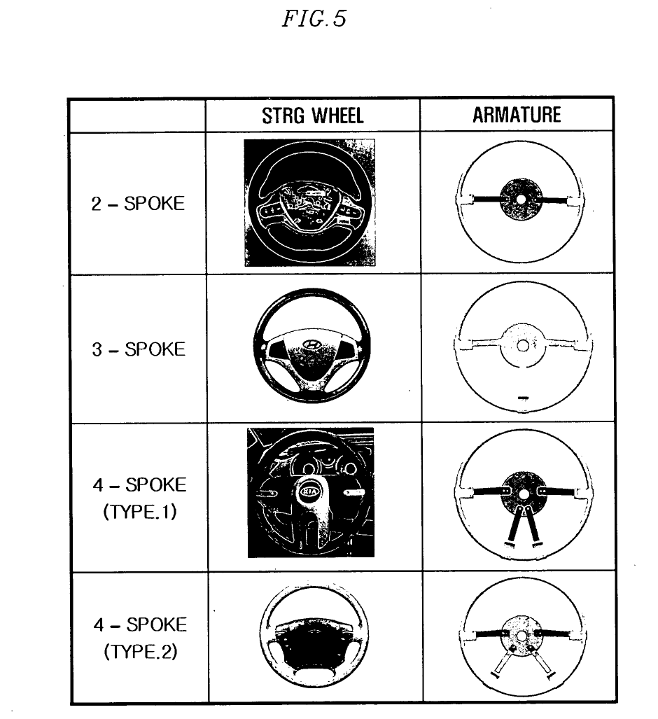

As shown in FIG. 5, according to an exemplary embodiment of the present invention, various armatures 120 can be formed by changing the number and the position of the spoke 210, and thus various steering wheels 100 can be manufactured.

According to an exemplary embodiment of the present invention, even when a rim, a hub, and a spoke are formed to respectively have one type, various armatures can be formed by changing the number and the position of the spoke when assembling with the hub and the rim. Furthermore, there is no need to prepare respective molds for forming various armatures, and thus it can reduce time and cost involved in manufacturing the molds.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An armature of a steering wheel, comprising:
a rim;
a hub disposed in a middle portion of the rim; and
at least one spoke having one end portion combined with the hub and the other end portion combined with the rim, wherein, when the spoke is combined with the rim and the hub, the number and the location of the spoke can be changed.

2. The armature of claim 1, wherein the hub comprises:
a base plate with a plurality of first insert grooves, the first insert grooves being formed at a top surface of the base plate and the spoke being inserted therein;
an upper plate with a plurality of second insert grooves corresponding to the first insert grooves, the second insert grooves being formed at a bottom surface of the base plate; and
a cover plate for combining the base plate and the upper plate.

3. The armature of claim 2, wherein:
a first coupling hole is provided at the end portion of the spoke to be combined with the hub, a second coupling hole is provided at each of the first insert grooves, a third coupling hole is provided at each of the second insert grooves, and a plurality of coupling pins are provided at a bottom surface of the cover plate; and
wherein the coupling pins are simultaneously inserted into the first, the second, and the third coupling holes so as to combine the spoke, the base plate, and the upper plate.

4. The armature of claim 2, wherein the position where the spoke is inserted into the plurality of first insert grooves can be changed, to thereby change the location of the spoke when combined with the rim and the hub.

5. The armature of claim 2, wherein the cover plate is combined with the upper plate by a hinge.

6. The armature of claim 1, wherein the other end portion of the spoke is provided with a clip for hooking the rim.
